(19) United States
(12) Patent Application Publication
(10) Pub. No.: US 2018/0228163 A1
(43) Pub. Date: Aug. 16, 2018

(54) FACILITATING PLANT GROWTH WITH ENVIRONMENTALLY-TOLERANT RHIZOBIA

(71) Applicant: NOVOZYMES BIOAG A/S, Bagsvaerd (DK)

(72) Inventors: Yaowei Kang, Chapel Hill, NC (US); Jessica Smith, Holly Springs, NC (US); Claire Pelligra, Raleigh, NC (US); Dougley McCallister, Christiansburg, VA (US); Kristi Woods, Blacksburg, VA (US)

(73) Assignee: NOVOZYMES BIOAG A/S, Bagsvaerd (DK)

(21) Appl. No.: 15/751,896

(22) PCT Filed: Aug. 12, 2016
(86) PCT No.: PCT/US2016/046833

§ 371 Date: Feb. 12, 2018

Related U.S. Application Data
(60) Provisional application No. 62/204,863, filed on Aug. 13, 2015.

(51) Int. Cl. A01N 63/00

(52) U.S. Cl. CPC A01N 63/00

(57) ABSTRACT

Disclosed are methods for using rhizobial bacteria that are at least partially tolerant to multiple adverse environmental conditions to stimulate growth of plants grown under conditions that are not optimal for plant growth.

### REFERENCE TO A DEPOSIT OF BIOLOGICAL MATERIAL

This application contains references of deposits of biological material, which deposits are incorporated herein by reference.

### BACKGROUND

Rhizobial bacteria can facilitate leguminous plant growth by supplying the plants with ammonium-based nitrogen after formation of symbiotic nodules with the plant roots (i.e., nitrogen fixation). Rhizobia may also facilitate plant growth by mechanisms other than nitrogen fixation, and may facilitate growth of plants that are not legumes. For example, certain rhizobial bacteria may produce plant growth regulators, solubilize nutrients and/or display activity against plant pathogens, any of which may facilitate plant growth.

Rhizobia are normally present in the soil, but also may be supplied to plants by coating the organisms onto seeds which are then planted, or by applying the rhizobia to a furrow in which seeds are planted. In order for rhizobia to facilitate plant growth, it is desirable that the organisms survive and function in the sometimes challenging environmental conditions encountered in the soil.

### SUMMARY

Rhizobial bacteria are disclosed that are tolerant to multiple adverse environmental conditions. When these bacteria are supplied to plants (e.g., legumes or non-legumes), methods to facilitate growth of the plants under the adverse environmental conditions, conditions under which control rhizobial bacteria do not facilitate plant growth, are possible. In one example, a Bradyrhizobium bacterium, a Bradyrhizobium japonicum bacterium or a Bradyrhizobium japonicum strain 370 bacterium that is tolerant or partially tolerant to multiple environmental conditions adverse for the bacterium is supplied to a plant. The environmental conditions to which the bacterium is tolerant or partially tolerant include multiple of coating the bacterium onto a seed, exposure of the bacterium to low temperature, exposure of the bacterium to molybdenum, exposure of the bacterium to glyphosate, and exposure of the bacterium to high temperature. Once the bacterium is supplied to a plant, the plant may be grown. In one example, the plant may be grown under one or more conditions adverse for the plant (e.g., conditions not optimal for plant growth).

In one example, the disclosed rhizobial bacteria, used in the disclosed methods, are tolerant or partially tolerant to conditions encountered during and/or after coating the bacteria onto a seed (e.g, the bacteria retain viability on seed). In one example, the disclosed rhizobial bacteria are tolerant or partially tolerant to low temperature (e.g., one or more of 50° F., 55° F., 60° F.). In one example, the rhizobial bacteria that are tolerant to low temperature facilitate seed germination at the low temperatures, which are temperatures below those at which seeds are capable of germinating, or efficiently germinating, without the bacteria. In one example, the disclosed rhizobial bacteria are tolerant or partially tolerant to certain chemical substances, such as molybdenum and/or glyphosate. In one example, the rhizobial bacteria are tolerant to concentrations of molybdenum and/or glyphosate, and can facilitate plant growth at those concentrations of molybdenum and/or glyphosate at which control rhizobia may not facilitate plant growth. In one example, the concentration of molybdenum may be at least 260 mM. In one example, the concentration of glyphosate may be about 2 mM or greater. In one example, the disclosed rhizobial bacteria are tolerant to high temperatures and may facilitate plant growth at temperatures where control rhizobia do not. In one example, the high temperature may be about 100° F. The disclosed rhizobial bacteria may be tolerant to multiple of these adverse environmental conditions and, therefore, make possible methods for facilitating plant growth under multiple of these conditions.

In one example, the method may be a method for facilitating plant growth by coating a seed with a Bradyrhizobium bacterium, a Bradyrhizobium japonicum bacterium or a Bradyrhizobium japonicum strain 370 bacterium, the bacterium tolerant or partially tolerant to multiple adverse conditions. The seed may be planted. The seed may be grown. In one example, the method may be a method for supplying to a furrow a Bradyrhizobium bacterium, a Bradyrhizobium japonicum bacterium or a Bradyrhizobium japonicum strain 370 bacterium, the bacterium tolerant or partially tolerant to multiple adverse conditions. The seed may be planted in the furrow. The seed may be grown. In one example, the seed may be soybean and the soybean seeds may be planted in March, April or May in North America, or in September, October or November in South America. In one example, the soybean seed may be planted at a time when the average nightly temperature during the week in which planting is performed is less than 50° F., 55° F. or 60° F. In one example, the soybean seed may be planted in a location and at a time when a temperature of less than 50° F., 55° F. or 60° F. occurs once per 24-hour period during the week in which planting is performed. The bacterium may be capable of facilitating germination of seeds at these temperatures.

In one example, a seed or seedling may be planted in proximity to a Bradyrhizobium bacterium, a Bradyrhizobium japonicum bacterium or a Bradyrhizobium japonicum strain 370 bacterium that is tolerant/partially tolerant to multiple environmental conditions adverse for the bacterium. A plant may be grown from the seedling under conditions where the proximity of the bacterium and the seed or seedling is such that the bacterium can facilitate or enhance growth of the plant. In one example, the plant that is grown has a greater yield than a similar plant grown absent the bacterium.

In one example, a Bradyrhizobium bacterium, a Bradyrhizobium japonicum bacterium or a Bradyrhizobium japonicum strain 370 bacterium that is tolerant or partially tolerant to multiple environmental conditions adverse for the bacterium is provided to a person who is desirous of supplying the bacterium to a plant.

### BRIEF DESCRIPTION OF THE DRAWINGS

In the accompanying figures, which are incorporated in and constitute a part of the specification, disclosures related to methods of using environmentally-tolerant rhizobia to facilitate plant growth are disclosed. The figures are shown for the purpose of illustration and not for limitation. Changes, modifications and deviations from the disclosures illustrated in the figures may be made without departing from the spirit and scope of the invention, as disclosed below.

FIG. 1 illustrates example data from a study examining survival of bacteria on seeds.

FIG. 2 illustrates example data from a study examining survival of bacteria on seeds.

FIG. 3 illustrates example data from a study examining survival of bacteria on seeds.

FIG. 4 illustrates example data from a study examining yield of soybean pods.

FIG. 5 illustrates example data from a study examining bacterial growth at different temperatures.

### DETAILED DESCRIPTION

### Definitions

The following includes definitions of selected terms and phrases that may be used in the disclosure. Both singular and plural forms of the terms and phrases fall within the definitions.

As used herein, the term “adverse environmental condition” means an environmental condition which may result in decreased viability, growth and/or functioning, of a living organism (e.g., bacterium and/or plant). An environmental condition that is adverse for an organism, therefore, is a state or condition that is generally detrimental or not optimal for one or more of viability, growth, division, or functioning of that organism.

As used herein, “coating a seed” means applying a substance (e.g., bacteria) to a seed. Bacteria coated onto a seed may be referred to as bacteria that are “on seed.” Generally, after coating, the resulting seed has a layer on the seed that includes the applied substance. Coating a seed with a bacterium is one way of supplying the bacterium to a plant. Coating a bacterium onto a seed may be an environmental condition that is adverse for the bacterium, as discussed elsewhere herein.

As used herein, “desirous of supplying a bacterium to a plant” generally refers to a person, organization, or other entity, that obtains the bacterium for the purpose of supplying it to a plant to facilitate plant growth. In one example, a person who obtains the bacterium by purchasing it, especially in the case where the bacterium is being sold, marketed, registered, and/or the like, as suitable for supplying to a plant, is desirous of supplying the bacterium to a plant. The person, organization, or other entity, that is selling, marketing or registering the bacterium is the provider of the bacterium, directly or indirectly, to the person who is desirous of supplying the bacterium to a plant.

As used herein, “effective amount” means the amount, concentration, dosage and the like, sufficient to provide an effect. Generally, herein, effective amount refers to an amount of rhizobia supplied to plants that is able to have an effect. In this context, the effect normally will be facilitation of plant growth.

As used herein, the term “environmental condition” means any of a number of states or conditions to which a living organism (e.g., bacterium and/or a plant) may be exposed.

As used herein, the terms “facilitate”, “enhance” or “promote”, as related to plant growth, means that plant growth is generally improved for one or more factors or properties as compared to a standard or control. Herein, improved growth generally may be due to a rhizobial bacterium that has been supplied to the plant. In this situation, the bacterium may be said to have facilitated, enhanced or promoted plant growth. The standard or control for the situation where a rhizobium bacterium facilitates plant growth may be a situation where no rhizobial bacterium has been supplied, or a situation where a bacterium has been supplied, but has no effect or a lesser effect on plant growth than the rhizobial bacterium that is said to facilitate plant growth. The statement that a rhizobial bacterium facilitates plant growth does not imply a mechanism by which plant growth is facilitated. Rhizobial bacteria may facilitate plant growth by different mechanisms and/or multiple mechanisms which may operate dependently or independently.

As used herein, the term “facilitate seed germination” means a situation where supply of a component (e.g., a rhizobial bacterium) results in seed germination where there is no seed germination in absence of the component, or where supply of a component results in an increase in seed germination (e.g., faster, increase in percentage of seeds that germinate, and the like) over that occurring in absence of the component. Facilitating seed germination is encompassed by the term facilitate plant growth (i.e., a component that facilitates seed germination also facilitates plant growth; a component that facilitates plant growth may not necessarily facilitate seed germination).

As used herein, “fixed nitrogen” means nitrogen forms produced by nitrogen fixation in bacteria. Generally, fixed nitrogen includes ammonium (NH₄⁺) forms of nitrogen. Fixed nitrogen is a form of nitrogen that can be used by plants. Nitrogen fixation refers to the process whereby fixed nitrogen is produced.

As used herein, the term “growing a plant” means to place a plant (e.g., seed, seedling, mature plant) in a location and provide conditions under which the plant grows.

As used herein, the term “growing a plant under adverse environmental conditions” means that, during the time that a plant is in a location and exposed to conditions under which it does grow, that there is a least one period of time where environmental conditions adverse to the plant occur.

As used herein, “in furrow” means applying a substance (e.g., bacteria) to a trench in the soil where seeds are or will be planted. Applying bacteria to a furrow in which seeds are planted is one way of supplying the bacterium to a plant.

As used herein, the term “legume” or “leguminous plant” means plants of the family Fabaceae. Example legumes include alfalfa, clover, peas, cowpeas, beans, mung beans, lentils, lupins, mesquite, carob, soybeans, peanuts, tamarind, wisteria, siratro, plants from the Lespedeza genus, Genistoid legumes, serradella and others.

As used herein, “plant” means a living organism that typically grows in soil, absorbing water and inorganic substances through roots and synthesizing nutrients by photosynthesis. Plant includes all plants and plant populations, such as desired and undesired wild plants or crop plants (including naturally occurring crop plants). Typical plants may include trees, shrubs, herbs, grasses, ferns, mosses, flowers, fruit, vegetables, houseplants and others. In one example, plants may be legumes. In one example, plants may be nonlegumes. A plant may include the entirety of a plant or may include one or more forms, parts and/or organs of a plant, above or below ground. Plant includes all plant forms, parts and/or organs which may include, for example, shoots, leaves, flowers, roots, needles, stalks, stems, flowers, fruit bodies, fruits, seeds, roots, tubers, rhizomes, and the like. Plants may also include harvested material and vegetative and generative propagation material (e.g., cuttings, tubers, rhizomes, off-shoots and seeds, etc.).

As used herein, the term “plant growth” means all or part of the process that begins with a plant seed and continues to a mature plant. Generally, as a plant grows and/or matures from a seed planted in soil, the seed germinates, the plant emerges from the soil, and roots, stems and leaves form. Generally, as a plant grows, it will increase in size and mass. Plant growth may be determined by observing one or more aspects of a plant. For example, growth rate, amount of yield, root number, root length, root mass, root yield, leaf area, plant stand, plant vigor, or any of a number of other factors, individually or collectively, may be properties that may be observed and may correlate with plant growth.

As used herein, “rhizobium” or “rhizobial bacterium” means bacteria, generally from the soil, that can fix nitrogen and provide it in forms usable by plants. In one example, rhizobia form nodules on or within the roots of legume plants and provide nitrogen to plants. Rhizobial bacteria generally are grouped into one of the taxonomic families, Bradyrhizobiaceae, Brucellaceae, Hyphomicrobiaceae, Methylobacteriaceae, Phyllobacteriaceae, Rhizobiaceae and Burkholderiaceae. There are a number of different genera of bacteria that are within the rhizobium grouping. One genus of organisms therein includes Bradyrhizobium.

Bradyrhizobium japonicum is one species within the Bradyrhizobium genus. One strain of Bradyrhizobium japonicum is strain 370 (NRRL B-50728).

As used herein, “supplied to” or “supplying to” or “supplying”, specifically when used in the context of supplying rhizobial bacteria to a plant, means placing the bacteria in close enough proximity to the plant so that the bacteria, or substances produced by the bacteria, are capable of facilitating or enhancing growth of the plant, directly and/or indirectly. In this context, “placing” is a physical/mechanical act that results in the bacteria being located in close enough proximity to the plant so that growth can be facilitated or enhanced by the bacterium. In one example, when rhizobia are placed in close enough proximity to a plant to facilitate growth, the bacteria may be placed in proximity to one or more of the plant seed, or roots of a seedling or plant. In one example, the rhizobia may be applied to a seed. In one example, the rhizobia may be applied to a furrow in which a seed or seedling is planted (e.g., added into the soil near the seed, at planting). Other applications (e.g., foliar) are also included within the scope of the term “supplied to.”

As used herein, the term “tolerant” or “tolerance” generally refers to bacteria that retain viability, ability to grow and/or ability to function under one or more adverse environmental conditions. The term “partially tolerant” or “partial tolerance” refers to bacteria that partially retain viability, ability to grow and/or ability to function under one or more adverse environmental conditions. That is, the designation of a bacterium as tolerant or partially tolerant to one or more adverse environmental conditions indicates that the bacterium better retains the viability/growth/division/functioning properties compared to other bacteria that are not tolerant or partially tolerant. Tolerance may be used absolutely (e.g., the 370 strain of Bradyrhizobium japonicum is tolerant to high temperature because it can divide at a temperature of 38° C.) or may be used relatively (e.g., the 370 strain of Bradyrhizobium japonicum is tolerant to high temperature because it divides at a higher temperature than other strains of Bradyrhizobium japonicum or divides faster than other strains at the higher temperature).

The condition or state of a bacterium coated onto a seed may be an adverse environmental condition for the bacterium. Generally, in the process of coating a seed with bacteria, the bacteria are exposed to desiccation conditions. Also, when a seed that is coated with a bacterium is planted in the soil, the bacteria are generally exposed to rehydration conditions. Desiccation and/or rehydration are conditions that may result in decreased bacterial viability, growth, division and/or functioning. However, conditions other than, or in addition to, desiccation and/or rehydration may be responsible for and/or contribute to the adverse environmental condition of a bacterium being on seed. In one example, certain strains of bacteria may be considered tolerant to coating onto a seed because they retain viability better, longer, and the like, under the same “on-seed” conditions than do other strains of bacteria. “On-seed survival” generally refers to the property of or extent of bacteria retaining viability as part of a seed coat.

In one example, low temperatures may be an adverse environmental condition for bacteria, plants, or both. A low temperature that creates an environmental condition adverse for a bacterium may be different than a low temperature that creates an environmental condition adverse for a plant. In one example of a low temperature that is adverse for soybeans, the optimal temperature for germination of soybean seeds and emergence of the plants from the soil may be about 77° F. (25° C.). At 50° F. (10° C.), for example, germination and emergence of the plant may occur, but the processes likely occur more slowly than they occur at 77° F. Therefore, 50° F. may be considered an adverse environmental condition for soybeans, specifically for germination of a soybean seed and/or emergence of a seedling from the soil. In one example, certain strains of bacteria may be considered tolerant to low temperature because they are better able to cause germination of soybean seeds at that temperature than do other strains of bacteria. In one example, these bacteria may also be said to provide low-temperature tolerance to the soybeans. Certain low temperatures may be adverse for bacteria. For example, a Bradyrhizobium species may divide more slowly at temperatures below 28° C. than they do at 28° C. For this species, then, low temperatures that create an adverse environmental condition may occur below 28° C.

In one example, high temperatures may create an adverse environmental condition for bacteria, plants, or both. A high temperature that creates an environmental condition adverse for a bacterium may be different than a high temperature that creates an environmental condition adverse for a plant. In one example of a high temperature that is adverse for Bradyrhizoium japonicum, the 370 strain may divide and have an observable logarithmic phase of growth at 38° C., whereas other strains of this species may not divide, may have very limited cell division, or may divide with a doubling time less than the 370 strain at this temperature. In one example, the Bradyrhizobium japonicum 370 strain may facilitate plant growth at 38° C., whereas other strains of this species may not facilitate plant growth at this temperature. Therefore, 38° C. may be considered an adverse environmental condition for Bradyrhizoium japonicum. The 370 strain of Bradyrhizobium japonicum may be said to be tolerant or partially tolerant to this adverse environmental condition.

In one example, exposure to certain levels of certain chemical substances may be an adverse environmental condition for bacteria, plants or both. For example, certain concentrations of molybdenum may create an environmental condition adverse for plants or bacteria. In one example, concentrations of molybdenum commonly used to fertilize plants may be an adverse environment for bacteria. Certain strains of bacteria may be tolerant to these levels of molybdenum. Certain concentrations of glyphosate may create an environmental condition adverse for plants or bacteria. In one example, concentrations of glyphosate that are used to kill weeds, but to which genetically-modified, glyphosate resistant crops are tolerant, create an environmental condition that is adverse for bacteria. Certain strains of bacteria may be tolerant to these levels of glyphosate.

### Rhizobial Bacteria

Plants generally can utilize only certain forms of nitrogen, namely forms based on ammonium (NH₄⁺) or nitrate (NO₃⁻), but are not able to use molecular nitrogen (N₂). Ammonium- and/or nitrate-based compounds may not always be abundant in the soil and, therefore, may be limiting for plant growth. One solution to this problem is to add nitrogen-based fertilizers to the soil. But, use of these fertilizers can create problems that are well known. Another solution is that forms of nitrogen that can be used by plants may be supplied by diazotrophic (i.e., nitrogen-fixing) microbes. In some instances, these microbes may already be resident in the soil. It is also possible to supply the microbes in such a way that plant-usable forms of nitrogen produced by the microbes can be used by plants from the soil.

In one example, rhizobial bacteria are able to supply usable forms of nitrogen to leguminous plants. The grouping of bacteria known as rhizobia does not fall along strict taxonomic lines. The rhizobial grouping is known as a paraphyletic grouping, that includes organisms from both the alpha and beta classes of the phylum, Proteobacteria. Most rhizobia are α-proteobacteria bacteria that are part of the order, Rhizobiales (families Bradyrhizobiaceae, Brucellaceae, Hyphomicrobiaceae and Methylobacteriaceae, Phyllobacteriaceae and Rhizobiaceae). But, other rhizobia are β-proteobacteria bacteria that are part of the order Burkholderiales (family Burkholderiaceae). Rhizobial bacteria that form symbiotic relationships with legumes are generally from the genera Rhizobium, Ensifer, Mesorhizobium, Bradyrhizobium or Azorhizobi.

The genus, Bradyrhizobium, is a member of the family Bradyrhizobiaceae, and includes a number of species. For example, Bradyrhizobium betae, Bradyrhizobium elkanii, Bradyrhizobium diazoefficiens, Bradyrhizobium liaoningense, Bradyrhizobium japonicum, Bradyrhizobium yuanmingense and Bradyrhizobium canariense. In one example, B. elkanii, B. diazoefficiens and B. liaoningense may form symbioses with soybeans. In one example, B. japonicum may form symbioses with soybeans, cowpeas, mung beans and siratro. In one example, B. yuanmingense may form symbioses with legumes from the genus Lespedeza. In one example, B. canariense may form symbioses with certain Genistoid legumes, lupins and/or serradella.

In various examples, the rhizobial bacterium used in the methods may be from one of the taxonomic families that are included in the paraphyletic grouping known as rhizobia. In one example, the rhizobial bacterium used in the methods may be from the genus, Bradyrhizobium. In one example, the rhizobial bacterium used in these methods may be a Bradyrhizobium japonicum strain. In one example, the rhizobial bacterium used in these methods may be Bradyrhizobium japonicum strain 370 (NRRL B-50728).

In one example, the Bradyrhizobium japonicum is Bradyrhizobium japonicum strain 370. Strain 370 was isolated from a soybean root nodule in Aurora, Nebr., United States, on Apr. 26, 2010. As disclosed herein, this isolated strain and other equivalent strains are tolerant or partially tolerant to multiple environmental conditions adverse for bacteria. These bacteria can facilitate plant growth under environmental conditions that are adverse for the plant.

Control rhizobial strains, are generally not tolerant to multiple environmental conditions adverse for bacteria. Herein, some control strains include Bradyrhizobium japonicum strains 273, 273-17, 518 (NRRL B-50729), 727 (NRRL B-50730), 790, USDA 110, and the 21196 strain. The 273 strain is a Novozymes commercial strain. The 273-17 strain is a clone obtained from a mutagenized population of strain 273, which has improved tolerance to desiccation, but decreased ability to form nodules with plant roots. Strain 518 (NRRL B-50729) is a strain isolated from Portageville, Mo., United States, on Jul. 21, 2010. Strain 727 (NRRL B-50730) was isolated from Warren-Davenport, Ga., United States, on Oct. 25, 2010. Strain 790 was isolated from Prairie, Ark., United States, on Nov. 9, 2010. The USDA 110 strain was originally isolated from a soybean nodule in the State of Florida in the United States, in 1957 and is well known in the art. The 21196 strain is from a commercially marketed Bradyrhizobium product.

### Plants

Rhizobial bacteria generally can form symbioses with legume plants. Legumes include plants like alfalfa, clover, peas, beans, lentils, lupins, mesquite, carob, soybeans, peanuts, tamarind, wisteria, and many others. Taxonomically, legumes are part of the family Fabaceae (or Leguminosae).

Soybeans are legumes that are part of the genus, Glycine. There are two subgenera within the Glycine genus. Cultivated soybeans (genus, Glycine; species max) and wild annual soybeans (Glycine soya) belong to the Soja subgenus. The subgenus Glycine includes a number of wild perennial soybean species.

In various examples of the methods, the plant may be a leguminous plant from the family Fabaceae. In one example, the plant may be soybeans, cowpeas, mung beans, siratro, a Lespedeza, a Genistoid, a lupin, a serradella, or other legume.

In one example, the plant may be a non-legume. Certain rhizobial bacteria may produce plant growth regulators, solubilize nutrients (or otherwise facilitate uptake of certain nutrients from the environment) and/or display activity against plant pathogens. These effects may be direct or indirect on the plant. In one example, these rhizobia may be known as plant growth-promoting rhizobacteria (PGPR). In one example, these bacteria may have growth-promoting effects on plants that are not legumes. In one example, the plant may be corn.

### Adverse Environmental Conditions

There may be multiple ways in which rhizobial bacteria facilitate plant growth. For example, rhizobial bacteria may facilitate plant growth, at least in part, by providing usable nitrogen to plants. Rhizobial bacteria may facilitate plant growth by influencing seed germination for example, through production and activity of Nod factors. Rhizobia may facilitate plant growth through other mechanisms. In order to provide these effects on plant growth, however, it is likely that the bacteria need to be viable, able to grow/divide, and/or able to function, under the environmental conditions to which they are exposed. Under environmental conditions outside of the range in which the bacteria are viable, can grow and/or function (e.g., “adverse” environmental conditions), the bacteria may have a reduced ability to facilitate plant growth. The rhizobial bacteria disclosed here have a larger number and range of environmental conditions under which they retain viability, ability to grow/divide, and/or ability to function. Therefore, these bacteria are better able to facilitate plant growth under certain adverse environmental conditions, than are other bacteria.

Some environmental conditions and adverse environmental conditions relevant to this disclosure are described below.

### On-Seed Survival

The disclosed rhizobial bacteria normally have better on-seed survival properties than control bacteria and, therefore, remain viable and capable of facilitating plant growth on-seed than control bacteria. One method of supplying a rhizobial bacterium to a plant is to coat the bacterium onto a seed. When the seeds are subsequently planted in soil, the bacteria are in close enough proximity to the seed and/or plant, that the bacteria can potentially facilitate growth of the plant. There are a variety of methods known for coating bacteria onto seeds. It is well known that viability of rhizobial bacteria decreases over time when coated onto a seed. This may be related to desiccation conditions associated with the seed coating process, rehydration conditions associated with planting seeds in soil, and/or other factors.

In one example, on-seed viability or survival of a bacterium coated onto a seed may be measured by eluting the bacteria from the seed (e.g., dissolving or hydrating the seed coating) at various times after the coating process and estimating the number of viable bacteria in the eluent. The number of viable bacteria can be estimated by diluting the eluent and counting the viable bacteria, by determining colony-forming-units on agar plates, for example. Comparison of the number of viable bacteria eluted from seed coats with the number of viable bacteria originally placed onto the seed can estimate the decrease in bacterial viability on-seed over time. Comparison of the number of viable bacteria after various times on seed, may yield an estimate of the rate of decrease in bacterial viability over time.

Generally, comparison of the viability of different rhizobial bacteria on seed, under the same set of environmental conditions, is used to estimate relative tolerance of the bacteria to seed coating. In one example, Bradyrhizobium japonicum strain 370 is more tolerant to seed coating than Bradyrhizobium japonicum strains 273, 273-17, 518, 727 and 790. Strain 370, therefore, is said to be tolerant to seed coating, relative to the other strains. In one example, Bradyrhizobium japonicum strain 370 has one or more of, less than 90.0% loss of viability after 3 days on the seed, less than 99.0% loss of viability of the bacterium after 7 days on the seed, and less than 99.9% loss of viability of the bacterium after 14 days on the seed, when the bacteria are coated onto seeds in YEM media and the seeds are kept at about 21-23° C. In one example, Bradyrhizobium japonicum strain 370 retains viability on seed better than Bradyrhizobium japonicum strains 273, 273-17, 518, 727, 790 and others. In some examples, viability of the inventive Bradyrhizobium may be at least 2-fold, 4-fold, 5-fold, 6-fold, 8-fold, 10-fold, 20-fold, or more, higher than Bradyrhizobium japonicum strains 273, 273-17, 518, 727, or 790, after 3 days on the seed, when the bacteria are coated onto seeds in YEM media and the seeds are kept at about 21-23° C.

### Facilitation of Seed Germination at Low Temperatures

The disclosed rhizobial bacteria normally are able to facilitate seed germination at certain low temperatures where seeds do not germinate without the bacteria, or germinate at a reduced rate without the bacteria. At these temperatures, control rhizobial bacteria cannot facilitate seed germination or facilitate seed germination at a reduced rate as compared to the inventive bacteria.

Selection of dates for planting soybeans is a compromise. On one hand, data indicate that higher soybean yields are obtained when crops are planted earlier in the year. On the other hand, planting too early can slow seed germination, seedling emergence, root development, and so forth, and increase susceptibility of the soybean plants to pathogens that cause plant rotting. In some cases, where soybeans are planted too early in the year, the stands can be lost, necessitating replanting. In part, the increased risks due to early planting are due to lower soil temperatures existing at that time of year. In the State of Iowa, in the United States, for example, the majority of soybeans are planted in early- to mid-May. Planting after that time likely results in a reduced yield. Planting prior to that time may increase the risk of replanting.

In one example, the rhizobial bacteria disclosed here, when supplied to soybean seeds, can facilitate germination at the lower temperatures that are prevalent early in the planting season, increase plant yield, and may make possible earlier-than-normal planting. In one example, therefore, the rhizobial bacteria are capable of facilitating seed germination at a temperature that is adverse for seed germination. In one example, the rhizobial bacteria facilitate seed germination where planting of the seeds in the United States, in North America, occurs in the months of May, April, or even March. In one example, the rhizobial bacteria facilitate seed germination where planting of the seeds in South America occurs in the months of November, October, or even September. In one example, the rhizobial bacteria may facilitate seed germination at temperatures of less than, or about 50° F., 55° F., 60° F., 65° F., 70° F. or 75° F. In one example, these temperatures may be average temperatures, average daily temperatures or average nightly temperatures during the week in which the planting is performed. In one example, these temperatures may be average, average daily or average nightly temperatures, during a 1-day period (24 hours), 2-day period, 3-day period, 4-day period, 5-day period, 6-day period, 8-day period, 10-day period, 12-day period or 14-day period during which the planting is performed.

Use of the disclosed rhizobial bacteria may facilitate seed germination at these temperatures. Use of the disclosed rhizobial bacteria may also increase yield from plants grown from seeds planted at times when these temperatures are found in the environment. Use of the disclosed bacteria, therefore, if supplied to plants, may allow planting of soybean seeds at a time earlier than would be possible without supplying the disclosed bacteria.

In one example, the disclosed rhizobial bacteria include Bradyrhizobium japonicum strain 370. In one example, control rhizobial bacteria include Bradyrhizobium japonicum strains 273, 273-17, 518, 727 and 790, and others. In some examples, when seeds are planted early in the planting season, germination of seeds, on average, may occur 1, 2, 3, 4, 5, 6, or 7 days; or 1, 2, 3, 4, 5, or 6 weeks earlier, when the seeds are supplied with inventive Bradyrhizobium, as compared to supplying the seeds with Bradyrhizobium japonicum strains 273, 273-17, 518, 727, 790, or with no bacteria. In some examples, when seeds are planted early in the planting season, at least 1%, 2%, 3%, 4%, 5%, 6%, 8%, 10%, 15%, 20%, 25%, 30%, 40%, 50%, 75%, or 100% more seeds may germinate when the seeds are supplied with inventive Bradyrhizobium, as compared to supplying the seeds with Bradyrhizobium japonicum strains 273, 273-17, 518, 727, 790, or with no bacteria.

### Tolerance to Chemical Substances—Molybdenum, Glyphosate

The disclosed rhizobial bacteria normally are able to facilitate plant growth in the presence of, or after being exposed to, certain levels of certain chemical substances. In one example, the disclosed rhizobial bacteria are tolerant to certain concentrations/durations of exposure to molybdenum and/or glyphosate. The disclosed rhizobial bacteria, therefore, may facilitate plant growth under adverse environmental conditions due to molybdenum and/or glyphosate.

In one example, the concentration of molybdenum to which the disclosed rhizobial strains are tolerant is at least about 260 mM. In one example, the concentrations of molybdenum to which the disclosed rhizobial strains are tolerant may be at least one of 50, 100, 150, 175, 200, 225, 250, 275, 300, 325, 350, 400 or 500 mM. In one example, the disclosed rhizobial strains are tolerant to at least 0.5, 1.0, 1.5, 2.0, 2.5, 3.0 or 3.5 mM molybdenum citrate. In one example, the disclosed rhizobial strains are tolerant to molybdic acid at concentrations of at least 5.5, 6.0 or 6.25 mM. In one example, the disclosed rhizobial strains are tolerant to molybdic acid at concentrations of at least 6.17 mM.

In one example, the concentration of glyphosate to which the disclosed rhizobial strains are tolerant is at least about 2 mM. In one example, the disclosed rhizobial strains are tolerant to at least 1.0, 1.5, 2.0, 2.5, 3.0, 3.5, 4.0, 4.5 or 5.0 mM glyphosate.

In one example, the disclosed rhizobial bacteria include Bradyrhizobium japonicum strain 370. In one example, prior art rhizobial bacteria include Bradyrhizobium japonicum strains 273, 273-17, 518, 727, 790, and others.

### Tolerance to High Temperature

The disclosed rhizobial bacteria are viable, can divide and/or function at high temperatures, and therefore are tolerant or partially tolerant to these temperatures. The disclosed rhizobial bacteria are capable of facilitating plant growth at these temperatures.

In one example, the temperature to which the disclosed rhizobial strains are tolerant is at least 32° C. (90° F.), 34° C. (93° F.), 36° C. (97° F.), 38° C. (100° C.), 39° C. (102° F.) or 40° C. (104° F.). Therefore, the disclosed bacterial strains may facilitate plant growth at least at these temperatures.

In one example, the disclosed rhizobial bacteria include Bradyrhizobium japonicum strain 370. In one example, prior art rhizobial bacteria include Bradyrhizobium japonicum strains 273, 273-17, 518, 727, 790 and others.

### Tolerance to Multiple Adverse Environmental Conditions

The disclosed rhizobial strains are tolerant to at least one, at least two, at least three, at least four or at least five adverse environmental conditions. In one example, adverse environmental conditions include: conditions/duration of coating onto a seed where viability, ability to grow/divide and/or function are inhibited; low temperatures that inhibit seed germination; duration/concentration of exposure to molybdenum where viability, ability to grow/divide and/or function are inhibited; duration/concentration of exposure to glyphosate where viability, ability to grow/divide and/or function are inhibited; and high temperatures that inhibit growth/division of other rhizobial bacteria. The tolerances to the various adverse environmental conditions may be present in any combination in the rhizobial strains.

In some examples, the disclosed rhizobial strains are not tolerant to one, two, or three of the five adverse environmental conditions, in any combination, disclosed herein (i.e., coating onto seeds, exposure to low temperatures, exposure to molybdenum, exposure to glyphosate, exposure to high temperatures).

In the methods disclosed herein, where supplied rhizobial bacteria facilitate plant growth, the plants may be grown under environmental conditions that are adverse for known rhizobial bacteria, for plants, or for both rhizobial bacteria and plants. The plants may be grown under at least one, at least two, at least three, at least four or at least five adverse environmental conditions. In one example, adverse environmental conditions include: rhizobial bacteria coated onto a seed; low temperatures that inhibit seed germination; exposure to molybdenum; exposure to glyphosate; and high temperatures.

### Combinations

The disclosed rhizobia, that are tolerant to multiple adverse environmental conditions, may be combined with other components and supplied to plants as a combination. In other examples, the rhizobial bacteria may be supplied as a combination before or after the other components.

In one example, the rhizobial bacteria may be combined with one or more plant signal molecules for use in the methods, the plant signal molecules including but not limited to, lipo-chitooligosaccharides (LCOs), chitooligosaccharides (COs), chitinous compounds (e.g., chitins, chitosans), flavonoids (e.g., daidzein, genistein, hesperitin, naringenin, lutiolin), jasmonic acid or derivatives thereof, linoleic acid or derivatives thereof, linolenic acid or derivatives thereof, karrikins nutrients (e.g., vitamins, macrominerals, trace minerals, organic acids, various elements), gluconolactones, glutathiones, biostimulants, and the like. Two or more of the above-listed compounds may be combined with the rhizobial bacteria. The plant signal molecules may be supplied in any suitable amount or concentration. The plant signal molecules may be supplied simultaneously with the rhizobial bacteria and/or prior to or after the rhizobial bacteria are supplied to plants. The plant signal molecules may be combined with the rhizobial bacteria and one or more other microorganisms, acaricides, fungicides, gastropodicides, herbicides, insecticides, nematicides, rodenticides, virucides, and the like. The activity of these combinations (e.g., their ability to facilitate plant growth) may be additive or synergistic. In one example, the activity of these combinations is not antagonistic.

In one example, the rhizobial bacteria may be combined with one or more other microorganisms for use in the methods. The other microorganisms may include, but are not limited to, bacteria, fungi, beneficial nematodes, viruses, and the like. In one example, the bacteria may be Gram-positive bacteria. In one example, the bacteria may be Gram-negative bacteria. The other microorganisms may include phosphate-solubilizing microorganisms. For example, the phosphate-solubilizing microorganism may include Penicillium bilaiae (formerly known as Penicillium bilaii or Penicillium bilaji). In one example, the other microorganisms may include mycorrhizal fungi. The other microorganisms may have one or both of biocontrol and inoculant properties. Two or more of the other microorganisms may be combined with the rhizobial bacteria for use in the methods. The other microorganisms may be supplied in any suitable amount or concentration. The other microorganisms may be supplied simultaneously with the rhizobial bacteria and/or prior to or after the rhizobial bacteria are supplied to plants. The other microorganisms may be combined with the rhizobial bacteria and one or more plant signal molecules, acaricides, fungicides, gastropodicides, herbicides, insecticides, nematicides, rodenticides, virucides, and the like. The activity of these combinations (e.g., their ability to facilitate plant growth) may be additive or synergistic. In one example, the activity of these combinations is at least not antagonistic.

In one example, the rhizobial bacteria may be combined with one or more acaricides, fungicides, gastropodicides, herbicides, insecticides, nematicides, rodenticides, and virucides. In some embodiments, the rhizobial bacteria include one or more biopesticides (e.g., one or more bioacaricides, biofungicides, bioinsecticides and/or bionematicides) for use in the methods.

The rhizobial bacteria may be combined with any suitable acaricide(s), including, but not limited to, biological acaricides and chemical acaricides. Acaricides may be selected so as to provide effective control against a broad spectrum of acarids, including, but not limited to, phytoparasitic acarids from the families Eriophydiae, Penthaleidae, Tarsonemidae, and/or Tetranychidae. In some examples, the rhizobial bacteria may be combined with an acaricide (or combination of acaricides) that is toxic to one or more species of Abacarus (e.g., A. acutatus, A. doctus, A. hystrix, A. lolii, A. sacchari), Aberoptus, Acalitus (e.g., A. essigi), Acanthonychus, Acaphylla, Acaphyllisa, Acaralox, Acarelliptus, Acaricalus, Acarus (e.g., A. siro), Aceria (e.g., A. chondrillae, A. guerreronis, A. malherbae, A. sheldoni), Achaetocoptes, Acritonotus, Aculochetus, Aculodes, Aculops, Aculus, Adenoptus, Aequsomatus, Afronobia, Allonychus, Amphitetranychus, Anatetranychus, Anthocoptes, Aplonobia, Aponychus, Atetranychus, Atrichoproctus, Bariella, Beerella, Boczekiana, Brachendus, Brevinychus, Bryobia, Bryobiella, Bryocopsis, Calacarus, Calepitrimerus, Callyntrotus, Cecidophyes, Cecidophyopsis, Cisaberiptus, Colomerus, Coptophylla, Cosetacus, Criotacus, Crotonella, Cupacarus, Cymoptus, Dasyobia, Dichopelmus, Ditrymacus, Dolichonobia, Duplanychus, Edella, Eonychus, Eotetranychus, Epitrimerus, Eremobryobia, Eriophyes (e.g., E. padi), Eurytetranychini, Eurytetranychus, Eurytetranychoides, Eutetranychus, Evertella, Floridotarsonemus, Gilarovella, Glyptacus, Hellenychus, Hemibryobia, Hystrichonychini, Hystrichonychus, Keiferella, Leipothrix, Lindquistiella, Liroella, Magdalena, Marainobia, Mesalox, Mesobryobia, Metaculus, Meyernychus, Mezranobia, Mixonychus, Monoceronychus, Monochetus, Mononychellus, Neooxycenus, Neoschizonobiella, Neotegonotus, Neotetranychus, Neotrichobia, Notonychus, Oligonychus, Oxycenus, Palmanychus, Panonychus (e.g., P. citri and/or P. ulmi), Parapetrobia, Paraphytoptus, Paraplonobia, Paraponychus, Peltanobia, Pentamerus, Petrobia, Petrobiini, Phyllocoptes, Phyllocoptruta, Phytonemus, Platytetranychus, Polyphagotarsonemus, Platyphytoptus, Porcupinychus, Pseudobryobia, Reckella, Schizonobia, Schizonobiella, Schizotetranychus, Shevtchenkella, Sinobryobia, Sinotetranychus, Sonotetranychus, Stenacis, Steneotarsonemus, Strunkobia, Synonychus, Tarsonemus, Tauriobia, Tegolophus, Tegonotus, Tegoprionus, Tenuipalpoides, Tenuipalpoidini, Tenuipalponychus, Tetra, Tetranychinae, Tetranychini, Tetranychopsis, Tetranychus (e.g., T. cinnabarinus, T. lintearius, T urticae), Tetraspinus, Thamnacus, Toronobia, Tumescoptes, Vasates, Xinella, Yezonychus, and/or Yunonychus.

The rhizobial bacteria may be combined with any suitable insecticide(s), including, but not limited to, biological insecticides and chemical insecticides. Insecticides may be selected so as to provide effective control against a broad spectrum of insects, including, but not limited to, insects from the orders Coleoptera, Dermaptera, Diptera, Hemiptera, Homoptera, Hymenoptera, Lepidoptera, Orthoptera and Thysanoptera. For example, one or more insecticides may be toxic to insects from the families Acrididae, Aleytodidae, Anobiidae, Anthomyiidae, Aphididae, Bostrichidae, Bruchidae, Cecidomyiidae, Cerambycidae, Cercopidae, Chrysomelidae, Cicadellidae, Coccinellidae, Cryllotalpidae, Cucujidae, Curculionidae, Dermestidae, Elateridae, Gelechiidae, Lygaeidae, Meloidae, Membracidae, Miridae, Noctuidae, Pentatomidae, Pyralidae, Scarabaeidae, Silvanidae, Spingidae, Tenebrionidae, and/or Thripidae. In some examples, the rhizobial bacteria may be combined with an insecticide (or combination of insecticides) that is toxic to one or more species of Acalymma, Acanthaoscelides (e.g., A. obtectus), Anasa (e.g., A. tristis), Anastrepha (e.g., A. ludens), Anoplophora (e.g., A. glabripennis), Anthonomus (e.g., A. eugenii), Acyrthosiphon (e.g., A. pisum), Bactrocera (e.g. B. dosalis), Bemisia (e.g., B. Argentifolii, B. tabaci), Brevicoryne (e.g., B. brassicae), Bruchidius (e.g., B. atrolineatus), Bruchus (e.g., B. atomarius, B. dentipes, B. lentis, B. pisorum, and/or B. rufipes), Callosobruchus (e.g., C. chinensis, C. maculatus, C. rhodesianus, C. subinnotatus, C. theobromae), Caryedon (e.g., C. serratus), Cassadinae, Ceratitis (e.g., C. capitata), Chrysomelinae, Circulifer (e.g., C. tenellus), Criocerinae, Cryptocephalinae, Cryptolestes (e.g., C. ferrugineus, C. pusillis, C. pussilloides), Cylas (e.g., C. formicarius), Delia (e.g., D. antiqua), Diabrotica, Diaphania (e.g., D. nitidalis), Diaphorina (e.g., D. citri), Donaciinae, Ephestia (e.g, E. cautella, E. elutella, E., keuhniella), Epilachna (e.g., E. varivestris), Epiphyas (e.g., E. postvittana), Eumolpinae, Galerucinae, Helicoverpa (e.g., H. zea), Heteroligus (e.g., H. meles), Iobesia (e.g., I. botrana), Lamprosomatinae, Lasioderma (e.g., L. serricorne), Leptinotarsa (e.g., L. decemlineata), Leptoglossus, Liriomyza (e.g., L. trifolii), Manducca, Melittia (e.g., M. cucurbitae), Myzus (e.g., M. persicae), Nezara (e.g., N. viridula), Orzaephilus (e.g., O. merator, O. surinamensis), Ostrinia (e.g., O. nubilalis), Phthorimaea (e.g., P. operculella), Pieris (e.g., P. rapae), Plodia (e.g., P. interpunctella), Plutella (e.g., P. xylostella), Popillia (e.g., P. japonica), Prostephanus (e.g., P. truncates), Psila, Rhizopertha (e.g., R. dominica), Rhopalosiphum (e.g., R. maidis), Sagrinae, Solenopsis (e.g., S. Invicta), Spilopyrinae, Sitophilus (e.g., S. granaries, S. oryzae, and/or S. zeamais), Sitotroga (e.g., S. cerealella), Spodoptera (e.g., S. frugiperda), Stegobium (e.g., S. paniceum), Synetinae, Tenebrio (e.g., T. malens and/or T molitor), Thrips (e.g., T. tabaci), Trialeurodes (e.g., T. vaporariorum), Tribolium (e.g., T. castaneum and/or T. confusum), Trichoplusia (e.g., T. ni), Trogoderma (e.g., T. granarium), and Trogossitidae (e.g., T. mauritanicus).

The rhizobial bacteria may be combined with any suitable nematicide(s) including, but not limited to, biological nematicides and chemical nematicides. Nematicides may be selected so as to provide effective control against a broad spectrum of nematodes, including, but not limited to, phytoparasitic nematodes from the classes Chromadorea and Enoplea. In some examples, the rhizobial bacteria may be combined with an a nematicide (or combination of nematicides) that is toxic to one or more strains of Anguina, Aphelenchoides, Belonolaimus, Bursaphelenchus, Ditylenchus, Globodera, Helicotylenchus, Heterodera, Hirschmanniella, Meloidogyne, Naccobus, Pratylenchus, Radopholus, Rotylenshulus, Trichodorus, Tylenchulus, and/or Xiphinema.

The rhizobial bacteria may be combined with one or more biological acaricides, insecticides, and/or nematicides (i.e., one or more microorganisms the presence and/or output of which is toxic to an acarid, insect and/or nematode). In one example, the rhizobial bacteria may be combined with one or more chemical acaricides, insecticides, and/or nematicides. For example, in some examples, the rhizobial bacteria may be combined with one or more carbamates, diamides, macrocyclic lactones, neonicotinoids, organophosphates, phenylpyrazoles, pyrethrins, spinosyns, synthetic pyrethroids, tetronic acids and/or tetramic acids. Non-limiting examples of chemical acaricides, insecticides, and nematicides that may be useful include acrinathrin, alpha-cypermethrin, betacyfluthrin, cyhalothrin, cypermethrin, deltamethrin, csfenvalcrate, etofenprox, fenpropathrin, fenvalerate, flucythrinate, fosthiazate, lambda-cyhalothrin, gamma-cyhalothrin, permethrin, tau-fluvalinate, transfluthrin, zeta-cypermethrin, cyfluthri, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (e.g., Rynaxypyr), cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, cadusaphos, carbaryl, carbofuran, ethoprophos, thiodicarb, aldicarb, aldoxycarb, metamidophos, methiocarb, sulfoxaflor, cyantraniliprole, and tioxazofen, and combinations thereof.

The rhizobial bacteria may be combined with any suitable fungicide(s), including, but not limited to, biological fungicides and chemical fungicides. Fungicides may be selected so as to provide effective control against a broad spectrum of phytopathogenic fungi (and fungus-like organisms), including, but not limited to, soil-borne fungi from the classes Ascomycetes, Basidiomycetes, Chytridiomycetes, Deuteromycetes (syn. Fungi imperfecti), Peronosporomycetes (syn. Oomycetes), Plasmodiophoromycetes, and Zygomycetes. In some examples, the rhizobial bacteria may be combined with a fungicide (or combination of fungicides) that is toxic to one or more strains of Albugo (e.g., A. candida), Alternaria (e.g. A. alternata), Aspergillus (e.g., A. candidus, A. clavatus, A. flavus, A. fumigatus, A. parasiticus, A. restrictus, A. sojae, A. solani), Blumeria (e.g., B. graminis), Botrytis (e.g., B. cinerea), Cladosporum (e.g., C. cladosporioides), Colletotrichum (e.g., C. acutatum, C. boninense, C. capsici, C. caudatum, C. coccodes, C. crassipes, C. dematium, C. destructivum, C. fragariae, C. gloeosporioides, C. graminicola, C. kehawee, C. lindemuthianum, C. musae, C. orbiculare, C. spinaceae, C. sublineolum, C. trifolii, C. truncatum), Fusarium (e.g., F. graminearum, F. moniliforme, F. oxysporum, F. roseum, F. tricinctum), Helminthosporium, Magnaporthe (e.g., M. grisea, M. oryzae), Melamspora (e.g., M. lini), Mycosphaerella (e.g., M graminicola), Nematospora, Penicillium (e.g., P. rugulosum, P. verrucosum), Phakopsora (e.g., P. pachyrhizi), Phomopsis, Phytiphtoria (e.g., P. infestans), Puccinia (e.g., P. graminis, P. striiformis, P. tritici, P. triticina), Pucivinia (e.g., P. graministice), Pythium, Pytophthora, Rhizoctonia (e.g., R. solani), Scopulariopsis, Selerotinia, Thielaviopsis, and/or Ustilago (e.g., U. maydis).

The rhizobial bacteria may be combined with one or more chemical fungicides. In some examples, the rhizobial bacteria may be combined with one or more aromatic hydrocarbons, benzimidazoles, benzthiadiazole, carboxamides, carboxylic acid amides, morpholines, phenyl amides, phosphonates, quinone outside inhibitors (e.g. strobilurins), thiazolidines, thiophanates, thiophene carboxamides, and/or triazoles. Non-limiting examples of chemical fungicides that may be useful combination with the rhizobial bacteria may include strobilurins, such as azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrylic acid methyl ester, and 2-(2-(3-(2,6-dichlorophenyl)-1-methyl-allylideneaminooxymethyl)-phenyl)-2-methoxyimino-N-methyl-acetamide; carboxamides, such as carboxanilides (e.g., benalaxyl, benalaxyl-M, benodanil, bixafen, boscalid, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyra-zole-4-carboxamide, N-(2-(1,3,3-trimethylbutyl)-phenyl)-1,3-dimethyl-5-fluoro-1H-pyrazole-4-carboxamide), carboxylic morpholides (e.g., dimethomorph, flumorph, pyrimorph), benzoic acid amides (e.g., flumetover, fluopicolide, fluopyram, zoxamide), carpropamid, dicyclomet, mandiproamid, oxytetracyclin, silthiofam, and N-(6-methoxy-pyridin-3-yl) cyclopropanecarboxylic acid amide; azoles, such as triazoles (e.g., azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole) and imidazoles (e.g., cyazofamid, imazalil, pefurazoate, prochloraz, triflumizol); heterocyclic compounds, such as pyridines (e.g., fluazinam, pyrifenox (cf.D1b), 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine), pyrimidines (e.g., bupirimate, cyprodinil, diflumetorim, fenarimol, ferimzone, mepanipyrim, nitrapyrin, nuarimol, pyrimethanil), piperazines (e.g., triforine), pirroles (e.g., fenpiclonil, fludioxonil), morpholines (e.g., aldimorph, dodemorph, dodemorph-acetate, fenpropimorph, tridemorph), piperidines (e.g., fenpropidin); dicarboximides (e.g., fluoroimid, iprodione, procymidone, vinclozolin), non-aromatic 5-membered heterocycles (e.g., famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester), acibenzolar-S-methyl, ametoctradin, amisulbrom, anilazin, blasticidin-S, captafol, captan, chinomethionat, dazomet, debacarb, diclomezine, difenzoquat, difenzoquat-methyl sulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole, and 5-chloro-7-(4-methylpiperidin-1-yl)-6-(2,4,6-trifluorophenyl)-[1,2,4]triazolo-[1,5-a]pyrimidine; benzimidazoles, such as carbendazim; and other active substances, such as guanidines (e.g., guanidine, dodine, dodine free base, guazatine, guazatine-acetate, iminoctadine), iminoctadine-triacetate, and iminoctadine-tris(albesilate); antibiotics (e.g., kasugamycin, kasugamycin hydrochloride-hydrate, streptomycin, polyoxine, and validamycin A), nitrophenyl derivates (e.g., binapacryl, dicloran, dinobuton, dinocap, nitrothal-isopropyl, tecnazen). organometal compounds (e.g., fentin salts, such as fentin-acetate, fentin chloride, fentin hydroxide); sulfur-containing heterocyclyl compounds (e.g., dithianon, isoprothiolane), organophosphorus compounds (e.g., edifenphos, fosetyl, fosetyl-aluminum, iprobenfos, phosphorus acid and its salts, pyrazophos, tolclofos-methyl), organochlorine compounds (e.g., chlorothalonil, dichlofluanid, dichlorophen, flusulfamide, hexachlorobenzene, pencycuron, pentachlorphenole and its salts, phthalide, quintozene, thiophanate-methyl, thiophanate, tolylfluanid, N-(4-chloro-2-nitro-phenyl)-N-ethyl-4-methyl-benzenesulfonamide), and inorganic active substances (e.g., Bordeaux mixture, copper acetate, copper hydroxide, copper oxychloride, basic copper sulfate, sulfur), and combinations thereof.

The rhizobial bacteria may be combined with any suitable gastropodicide(s), including, but not limited to, biological gastropodicides and chemical gastropodicides. Gastropodicides may be selected so as to provide effective control against a broad spectrum of gastropods, including, but not limited to, gastropods from the families Arionidae, Cochlicellidae, Helicidae and Hygromiidae. In some examples, the rhizobial bacteria may be combined with a gastropodicide (or combination of gastropodicides) that is toxic to one or more strains of Arion (e.g., A. vulgaris), Candidula (e.g., C. intersecta), Cernuella (e.g., C. virgata), Cochlicella (e.g., C. acuta), Hygromia (e.g., H. cinctella), Lissachatina (e.g., L. fulica), Microxeromagna (e.g., M. lowei), Monacha (e.g., M. cantiana, M. cartusiana, M. syriaca), Prietocella (e.g., P. Barbara), Xerolenta (e.g., X. obvia), Xeropicta (e.g., X. derbentina, X. krynickii), and/or Xerotricha (e.g., X. conspurcata).

The rhizobial bacteria may be combined with one or more chemical gastropodicides. For example, in examples, the rhizobial bacteria may be combined with one or more iron phosphates, metaldehydes, methiocarbs and/or salts. Non-limiting examples of chemical gastropodicides that may be useful include Deadline® M-Ps™, Mesurol Pro®, Mesurol 75-W®, Metarex and Sluggo®.

The rhizobial bacteria may be combined with any suitable herbicide(s), including, but not limited to, biological herbicides and chemical herbicides. Herbicides may be selected so as to provide effective control against a broad spectrum of plants, including, but not limited to, plants from the families Asteraceae, Caryophyllaceae, Poaceae, and Polygonaceae. In some examples, the rhizobial bacteria may be combined with a herbicide (or combination of herbicides) that is toxic to one or more strains of Echinochloa (e.g., E. brevipedicellata, E. callopus, E. chacoensis, E. colona, E. crus-galli, E. crus-pavonis, E. elliptica, E. esculenta, E. frumentacea, E. glabrescens, E. haploclada, E. helodes, E. holciformis, E. inundata, E. jaliscana, E. Jubata, E. kimberleyensis, E. lacunaria, E. macrandra, E. muricata, E. obtusiflora, E. oplismenoides, E. orzyoides, E. paludigena, E. picta, E. pithopus, E. polystachya, E. praestans, E. pyramidalis, E. rotundiflora, E. stagnina, E. telmatophila, E. turneriana, E. ugandensis, E. walteri), Fallopia (e.g., F. baldschuanica, F. japonica, F. sachalinensis), Stellaria (e.g., S. media), and/or Taraxacum (e.g., T. albidum, T. aphrogenes, T brevicorniculatum, T. californicum, T. centrasiatum, T. ceratophorum, T. erythrospermum, T. farinosum, T. holmboei, T. japonicum, T. kok-saghyz, T. laevigatum T. officinale, T. platycarpum).

The rhizobial bacteria may be combined with one or more chemical herbicides. For example, the rhizobial bacteria may be combined with one or more acetyl CoA carboxylase (ACCase) inhibitors, acetolactate synthase (ALS) inhibitors, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvyl shikimate-3-phosphate (EPSP) synthase inhibitor, glutamine synthetase inhibitor, dihydropteroate synthetase inhibitor, mitosis inhibitors, 4-hydroxyphenyl-pyruvate-dioxygenase (4-HPPD) inhibitors, synthetic auxins, auxin herbicide salts, auxin transport inhibitors, nucleic acid inhibitors, and/or one or more salts, esters, racemic mixtures and/or resolved isomers thereof. Non-limiting examples of chemical herbicides that may be useful include 2,4-dichlorophenoxyacetic acid (2,4-D), 2,4,5-trichlorophenoxyacetic acid (2,4,5-T), ametryn, amicarbazone, aminocyclopyrachlor, acetochlor, acifluorfen, alachlor, atrazine, azafenidin, bentazon, benzofenap, bifenox, bromacil, bromoxynil, butachlor, butafenacil, butroxydim, carfentrazone-ethyl, chlorimuron, chlorotoluro, clethodim, clodinafop, clomazone, cyanazine, cycloxydim, cyhalofop, desmedipham, desmetryn, dicamba, diclofop, dimefuron, diuron, dithiopyr, fenoxaprop, fluazifop, fluazifop-P, fluometuron, flufenpyr-ethyl, flumiclorac-pentyl, flumioxazin, fluoroglycofen, fluthiacet-methyl, fomesafe, fomesafen, glyphosate, glufosinate, haloxyfop, hexazinone, imazamox, imazaquin, imazethapyr, ioxynil, isoproturon, isoxaflutole, lactofen, linuron, mecoprop, mecoprop-P, mesotrion, metamitron, metazochlor, methibenzuron, metolachlor (and S-metolachlor), metoxuron, metribuzin, monolinuron, oxadiargyl, oxadiazon, oxyfluorfen, phenmedipham, pretilachlor, profoxydim, prometon, prometry, propachlor, propanil, propaquizafop, propisochlor, pyraflufen-ethyl, pyrazon, pyrazolynate, pyrazoxyfen, pyridate, quizalofop, quizalofop-P (e.g., quizalofop-ethyl, quizalofop-P-ethyl, clodinafop-propargyl, cyhalofop-butyl, diclofop-methyl, fenoxaprop-P-ethyl, fluazifop-P-butyl, haloxyfop-methyl, haloxyfop-R-methyl), saflufenacil, sethoxydim, siduron, simazine, simetryn, sulcotrione, sulfentrazone, tebuthiuron, tembotrione, tepraloxydim, terbacil, terbumeton, terbuthylazine, thaxtomin (e.g., the thaxtomins described in U.S. Pat. No. 7,989,393), thenylchlor, tralkoxydim, triclopyr, trietazine, tropramezone, and salts and esters thereof racemic mixtures and resolved isomers thereof, and combinations thereof.

The rhizobial bacteria may be combined with any suitable rodenticide(s), including, but not limited to, biological rodenticides and chemical rodenticides. Rodenticides may be selected so as to provide effective control against a broad spectrum of rodents, including, but not limited to, rodents from the families Cricetidae, Geomyoidae, and/or Talpidae In some examples, the rhizobial bacteria may be combined with a rodenticide (or combination of rodenticides) that is toxic to one or more strains of Condylura, Cratogeomys, Dymecodon, Ellobius, Eothenomys, Euroscaptor, Geomys (G. arenarius, G. bursarius, G. personatus, G. pinetis), Hyperacrius, Microtus (M. agrestis, M. arvalis, M. ochrogaster, M. pennsylvanicus, M pinetorum), Mogera, Mus, Myodes (M. glareolus), Neurotrichus, Orthogeomys, Pappogeomys (P. castanops), Parascalops, Parascaptor, Rattus, Scalopus, Scapanulus, Scapanus, Scaptochirus, Scaptonyx, Talpa, Thomomys (T. bottae, T. bulbivorus, T. idahoensis, T. mazama, T. monticola, T. talpoides, T. townsendii, T. umbrinus), Uropsilus, Urotrichus, and/or Zygogeomys.

The rhizobial bacteria may be combined with one or more chemical rodenticides. For example, in some examples, the rhizobial bacteria may be combined with brodifacoum, bromadiolone, bromethalin, cholecalciferol, chlorophacinone, difethialone, diphacinone, strychnine, warfarin, and/or zinc phosphide.

The rhizobial bacteria may be combined with suitable virucide(s), including, but not limited to, biological virucides and chemical virucides. Virucides may be selected so as to provide effective control against a broad spectrum of phytopathogenic viruses, including, but not limited to, viruses from the families Benyviridae, Closteroviridae, Geminiviridae, Potyviridae, Rhabdoviridae, and Virgaviridae. In some examples, the virucide(s) may be toxic to one or more strains of Begomovirus, Benyvirus, Carlavirus, Crinivirus, Furoviruus, Hordeivirus, Ipomovirus, Nucleorhabdovirus, Pecluvirus, Pomovirus, Tobamovirus, and/or Tobravirus. The rhizobial bacteria may be combined with one or more chemical virucides.

The rhizobial bacteria used in the methods may also be combined with substances such as microbial extracts, natural products, plant defense agents and the like.

For the components set forth in this section that may be combined with the rhizobial bacteria, two or more of the components may be combined with the rhizobial bacteria. The components may be supplied in any suitable amount or concentration. The activity of these combinations (e.g., their ability to facilitate plant growth) may be additive or synergistic. In one example, the activity of these combinations is not antagonistic.

### Formulations

The compositions disclosed herein may be formulated for various agricultural applications (e.g., seed coating formulations, foliar applications, in-furrow applications, drench applications, etc.). The compositions described herein may be formulated with at least one additional agricultural excipient to achieve a particular purpose (e.g., to coat seeds, for foliar applications, for dilution, etc.). Non-limiting examples of agricultural excipients include carriers, polymers, wetting agents, surfactants, anti-freezing agents, and the like, and combinations thereof.

In various examples, the compositions containing the rhizobial bacteria or the rhizobial bacteria, plus one or more additional components, may be in the form of a liquid, gel, slurry, solid, wettable or dry powder, and the like.

### EXAMPLES

The following examples are for the purpose of illustrating various embodiments and are not to be construed as limitations.

### Example 1. Survival of NRRL B-50728 (Strain 370) on Seed

Studies were performed to examine the ability of the NRRL B-50728 (370) strain of Bradyrhizobium japonicum to tolerate the process of application to seed and/or to survive on seeds over time (i.e., retain viability). Microbes normally go through a desiccation process when they are applied to seeds, and also normally go through a rehydration process when the seeds are then planted in the soil.

To perform this study, the 370 strain, as well as strains 273, 273-17, 518 (NRRL B-50729), 727 (NRRL B-50730) and 790 were separately inoculated into 5 ml tubes of YEM media (10 grams/liter (g/l) d-mannitol, 0.5 oxoid yeast extract, 0.1 NaCl, 0.5 K₂HPO₄, 0.2 MgSO₄.7H₂O, pH 6.8) and incubated for 3 days at 30° C. with shaking at 200 rpm. Bacteria from the culture tubes were then used to inoculate 50 ml cultures of YEM media such that the optical density at 600 nm (OD₆₀₀) of the culture was 0.03. These cultures were incubated at 30° C. with shaking at 200 rpm. After 3 days, the OD₆₀₀ of the cultures was determined. Cultures with OD₆₀₀ values within 0.3 of one another were used to coat seeds as described below.

To coat seeds with bacteria, each culture was adjusted so that 0.5 ml of the culture had an OD₆₀₀ of 0.5. One-half ml of these cultures were coated onto 30 soybean seeds in a 50 ml beaker. The seeds were positioned flat on the bottom of the beaker (i.e., seeds were not stacked on top of one another) and the liquid culture was evenly dispersed by rocking the beaker. Seeds were dry within 2 hours and then kept in the beaker at 21-23° C., unless indicated otherwise, and covered with autoclave paper during the duration of the study.

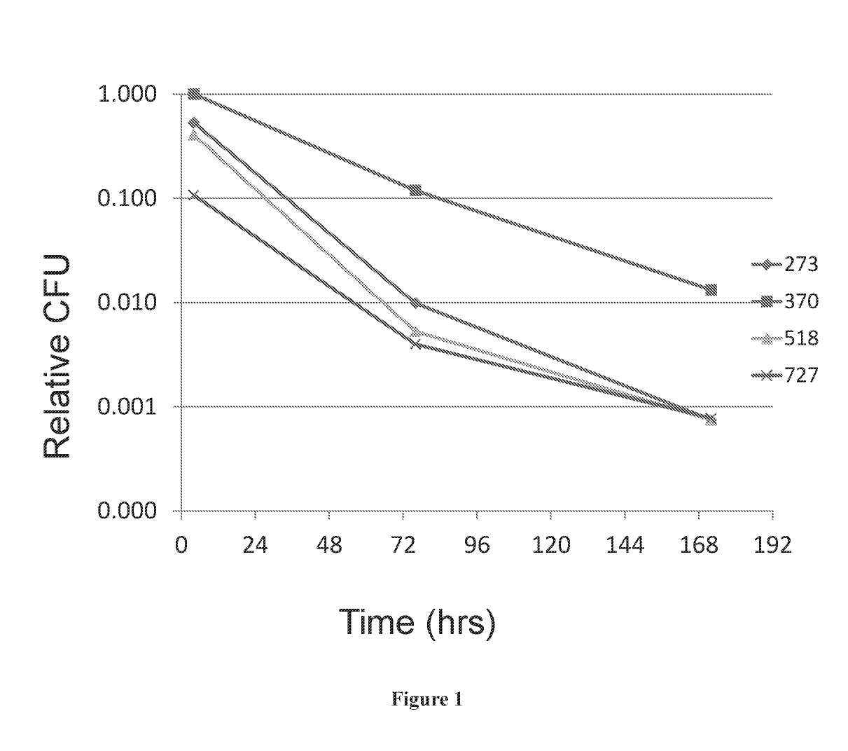

To determine survival of the strains on seeds, 3 seeds were taken from the beaker at various time points after the cultures had originally been added to the seeds (i.e., all time points were measured from the time the cultures were first added to the seeds), placed in sterile water, allowed to imbibe for 2 hours (i.e., rehydration), then serially diluted and plated on YEMA plates (YEM as described above, also containing 12 g/l agar) to obtain colony counts. The data are shown in Table 1 and in FIG. 1.

TABLE 1
Colony counts of microbes after various time on seed (values in
parenthesis shows colony numbers relative to the 370 strain at 4 hrs)

| Strain | 4 Hrs | 76 Hrs | 172 Hrs |
|---|---|---|---|
| 273 | 2.45 × 10⁷ | 4.55 × 10⁵ | 3.46 × 10⁴ |
| | (0.530) | (0.010) | (0.001) |
| 370 | 4.62 × 10⁷ | 5.48 × 10⁶ | 6.10 × 10⁵ |
| | (1.000) | (0.119) | (0.013) |
| 518 | 1.88 × 10⁷ | 2.44 × 10⁵ | 3.46 × 10⁴ |
| | (0.407) | (0.005) | (0.001) |
| 727 | 4.93 × 10⁶ | 1.84 × 10⁵ | 3.58 × 10⁴ |
| | (0.107) | (0.004) | (0.001) |

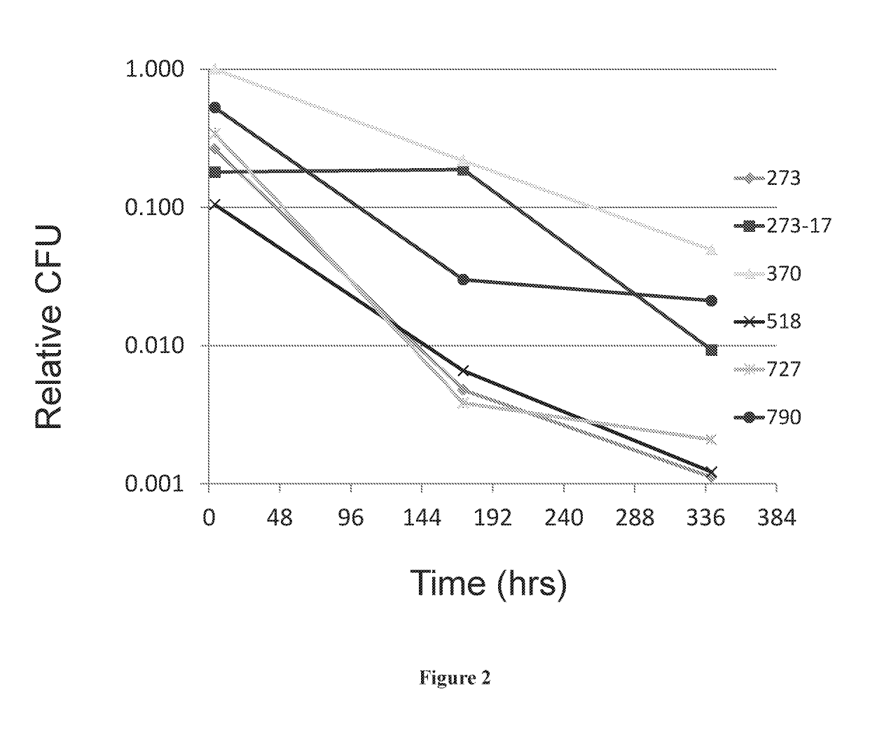

A second study was similarly performed and included some additional bacterial strains. The data are shown in Table 2 and in FIG. 2.

TABLE 2
Colony counts of microbes after various times on seed (in
parenthesis are colony numbers relative to the 370 strain at 4 hrs)

| Strain | 4 Hrs | 172 Hrs | 340 Hrs |
|---|---|---|---|
| 273 | 4.57 × 10⁶ | 8.21 × 10⁴ | 1.92 × 10⁴ |
| | (0.266) | (0.005) | (0.001) |
| 273-17 | 3.10 × 10⁶ | 3.23 × 10⁶ | 1.60 × 10⁵ |
| | (0.180) | (0.188) | (0.009) |
| 370 | 1.72 × 10⁷ | 3.74 × 10⁶ | 8.48 × 10⁵ |
| | (1.000) | (0.217) | (0.049) |
| 518 | 1.80 × 10⁶ | 1.13 × 10⁵ | 2.09 × 10⁴ |
| | (0.105) | (0.007) | (0.001) |
| 727 | 5.90 × 10⁶ | 6.60 × 10⁴ | 3.58 × 10⁴ |
| | (0.343) | (0.004) | (0.002) |
| 790 | 9.07 × 10⁶ | 5.16 × 10⁵ | 3.63 × 10⁵ |
| | (0.527) | (0.030) | (0.021) |

The data shown in Tables 1 and 2 indicate that viability of rhizobial bacteria coated onto seeds decreases over time. Loss of viability of the 370 strain is less than for the other strains. Based on optical density measurement of the cultures, the same amount of viable bacteria were placed on seeds for each of the different strains. Therefore, the differences in on-seed viability between the strains, observed at the first time point of 4 hours, indicated that the 370 strain retained viability better than the other strains. With the number of viable bacteria normalized to the 370 stain at 4 hours, almost a 10-fold drop in viability for the least tolerant strain was seen in both Table 1 (relative viability of strain 727 was 0.107) and Table 2 (relative viability of strain 518 was 0.105). Almost a 2-fold drop in viability was seen in Table 1 (relative viability of strain 273 was 0.530) and Table 2 (relative viability of strain 790 was 0.527) compared to the 370 strain. At later time points, loss of viability of the 370 strain was also less than that of the other strains.

### Example 2. Survival of NRRL B-50728 (Strain 370) Formulated Material on Seed

Additional studies were performed to examine the ability of the NRRL B-50728 (370) strain to tolerate the process of application to, and survival on, seed. In Example 1, the bacterial strains were coated onto seeds using water. In the studies described in this Example, the strains were grown in fermenters, essentially as described in Example 1, to the titers shown in Table 3 below, then formulated in a mixture of sucrose and sorbitol that contained a dispersant. Equivalent numbers of bacteria, in the formulated material, were applied at a rate of 300 μl per 100 g of seeds. Seeds were shaken in a sealed plastic bag for 2 min to allow even coating of the bacteria onto the seeds. For each strain, 6 replicates were prepared. The coated seeds were stored for various times, at various temperatures.

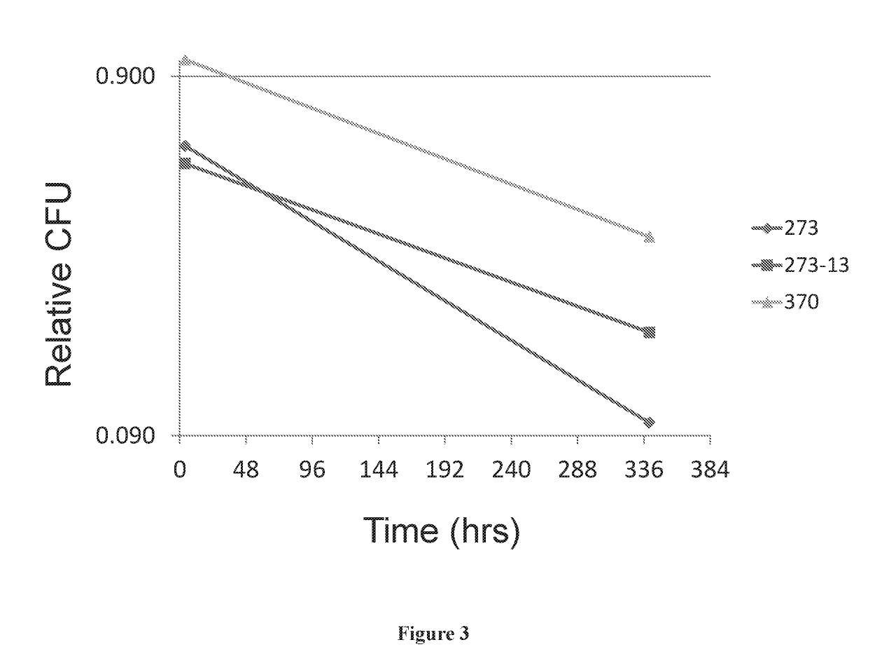

At various time points, duplicate samples were prepared from each replicate described above. For preparation of a sample, 50 coated seeds were placed in 50 ml of sterile phosphate buffer in a 250 ml flask. The flasks were shaken for 15 min. Then, serial dilutions were made and plated to obtain colony counts. The data are shown in Table 3 and FIG. 3.

TABLE 3
Colony counts of microbes after various times on seed at 23° C. (in
parenthesis are colony numbers relative to the 370 strain at 4 hrs)

| | Fermentation | | |
|---|---|---|---|
| Strain | titer (CFU/ml) | 4 Hrs | 340 Hrs |
| 273 | 1.11 × 10¹⁰ | 3.08 × 10⁵ | 5.23 × 10⁴ |
| | | (0.576) | (0.098) |
| 273-17 | 1.62 × 10¹⁰ | 2.75 × 10⁵ | 9.33 × 10⁴ |
| | | (0.514) | (0.174) |
| 370 | 1.07 × 10¹⁰ | 5.35 × 10⁵ | 1.72 × 10⁵ |
| | | (1.000) | (0.321) |

These data indicated that, even when rhizobial bacteria were coated onto seeds with a formulation designed, in part, to preserve bacterial viability, that differences between the strains in their tolerance to on-seed application were apparent. As shown in Table 3 and FIG. 3, the 370 strain was more tolerant to on-seed stress than were the other strains tested.

An additional study was similarly performed, to observe on-seed viability for a longer time period, and at two different temperatures. The data are shown in Table 4.

TABLE 4
Colony counts of microbes after various times on seed (in parenthesis
are colony numbers relative to the 4 hr time for each strain)

| | Temp | | | | | |
|---|---|---|---|---|---|---|
| Strain | (° C.) | 4 Hrs | 1 Wk | 2 Wk | 3 Wks | 4 Wks |
| 273, #1 | 10 | 1.60 × 10⁶ | 8.00 × 10⁵ | 5.10 × 10⁵ | 3.40E × 10⁵ | 2.44 × 10⁵ |
| | | (0.925) | (0.462) | (0.295) | (0.197) | (0.141) |
| | 21 | 1.60 × 10⁶ | 2.50 × 10⁵ | 4.50 × 10⁴ | 2.66 × 10⁴ | 1.67 × 10⁴ |
| | | (0.925) | (0.145) | (0.026) | (0.015) | (0.010) |
| 273-17, #1 | 10 | 8.60 × 10⁵ | 4.80 × 10⁵ | 3.00 × 10⁵ | 1.85 × 10⁵ | 1.82 × 10⁵ |
| | | (0.497) | (0.277) | (0.173) | (0.107) | (0.105) |
| | 21 | 8.60 × 10⁵ | 1.90 × 10⁵ | 9.20 × 10⁴ | 3.90 × 10⁴ | 2.65 × 10⁴ |
| | | (0.497) | (0.110) | (0.053) | (0.023) | (0.015) |
| 370, #1 | 10 | 1.73 × 10⁶ | 9.80 × 10⁵ | 6.90 × 10⁵ | 6.40 × 10⁵ | 4.00 × 10⁵ |
| | | (1.000) | (0.566) | (0.399) | (0.370) | (0.231) |
| | 21 | 1.73 × 10⁶ | 4.30 × 10⁵ | 1.70 × 10⁵ | 8.30 × 10⁴ | 4.10 × 10⁴ |
| | | (1.000) | (0.249) | (0.098) | (0.048) | (0.024) |

These data show that the 370 strain was more tolerant to on-seed conditions than were the 273 and 273-1 strains of Bradyrhizobium, measured out to 4 weeks (as compared to about 2 weeks for the data shown in Table 3. In addition, the data indicate that the rate at which microbe viability decreased on-seed was greater at 21° C. than at 10° C.

### Example 3. Survival of NRRL B-50728 (Strain 370) Formulated Material on Seed Based on Direct Counts

In the studies described in Examples 1 and 2, the same number of viable bacteria for each strain were placed on seeds. But the number of bacteria was not directly measured. Rather, quantification of the bacteria was based on equivalent optical density measurements of the cultures. In the study described here, the number of bacteria applied to seeds was directly measured.

In the study described in this example, the various Bradyrhizobium strains were grown, then formulated and placed in pliable bladders, and bladders stored at cool temperatures. Prior to coating soybean seeds with the bacteria, aliquots of the bacteria were obtained from each bladder, serially diluted and then plated to obtain colony counts, as described in Example 1. Using the colony counts, a known number of viable bacteria were applied to seeds, as described in Examples 1 and 2. Two hours after the bacteria were first added to the seeds, seeds were placed in sterile water, allowed to imbibe for 2 hours, then serially diluted and plated to obtain colony counts. The data in Table 5 show, for each strain, the number of viable bacteria recovered from seeds at 4 hours, expressed as a percentage of the number of viable bacteria applied to the seeds at time 0. Two studies were performed for each bacterial strain.

TABLE 5
Direct counts of bacteria
survival on seed

| Strain | Survivability at 4 hr (%) |
|---|---|
| 273, #1 | 33.0 |
| 273, #2 | 11.7 |
| 273-17, #1 | 33.7 |
| 273-17, #2 | 16.9 |
| 370, #1 | 45.2 |
| 370, #2 | 40.9 |

The data shown in Table 5 indicate that, based on direct bacterial counting, that the 370 strain of Bradyrhizobium japonicum was more tolerant to on-seed conditions than the control strains, 273 and 273-17.

### Example 4. Ability of NRRL B-50728 (Strain 370) to Facilitate Seed Germination at Low Temperature

A strain of rhizobial bacteria may be able to tolerate and divide at a low temperature. However, growth/division may not be indicative of the organism's ability to facilitate germination of seeds in the soil at the low temperature. To determine the ability of the 370 strain to facilitate seed germination, the following study was done.

Bradyrhzobium japonicum strains 370 and strain 273 were grown essentially as described in Examples 1 and 2. Soybean seeds were coated as described in Example 2 (100 μl of bacteria per 100 g of seed). Immediately after coating, seeds were stored at room temperature and ambient humidity in open bags for 4 hours. Then, the bags were sealed and stored at 30° C. for 3 days. The seeds were then removed from the bags and planted as below. Untreated seeds were used as a control.

Untreated seeds, seeds treated with strain 273 and seeds treated with strain 370, were each planted in three types of soil. First, 6 72 cell germination flats were filled with Metro-mix 830 soilless potting media. Two flats were sown with seeds from each treatment. Second, 48 one-gallon pots were filled with a 7:3:2 mix of Garden Mix (combination of leaf compost, topsoil, sawdust and manure; Landscape Store, Troutville, Va.), masonry sand (Landscape Store), and sphagnum peat (Fafard®). Sixteen pots were planted with 3 seeds per plot for each seed type (untreated, 273-treated, 370-treated). Third, 48 one-gallon pots were filled with Metro-mix 830 soilless potting media. As above, 16 of the pots were planted with 3 seeds per plot for each seed type. After emergence, plants were thinned to 1 per pot and allowed to grow for 19 weeks.

The temperature and light parameters were as below:

Day 1 (day seeds were planted)—room temperature was set to 55° F. and were lights set to 250 W/m²

Day 42 (after planting)—room temperature was set to 65° F. and lights were set to 300 W/m²

Day 63—room temperature remained at 65° F. and lights were set to 400 W/m²

Day 77—room temperature was set to 70° F. and lights were set to 500 W/m²

Day 98—room temperature was set to 75° F. and lights remained at 500 W/m²

Day 112—room temperature was set to 85° F. and lights remained at 500 W/m²

Day 133—plants were harvested and data obtained

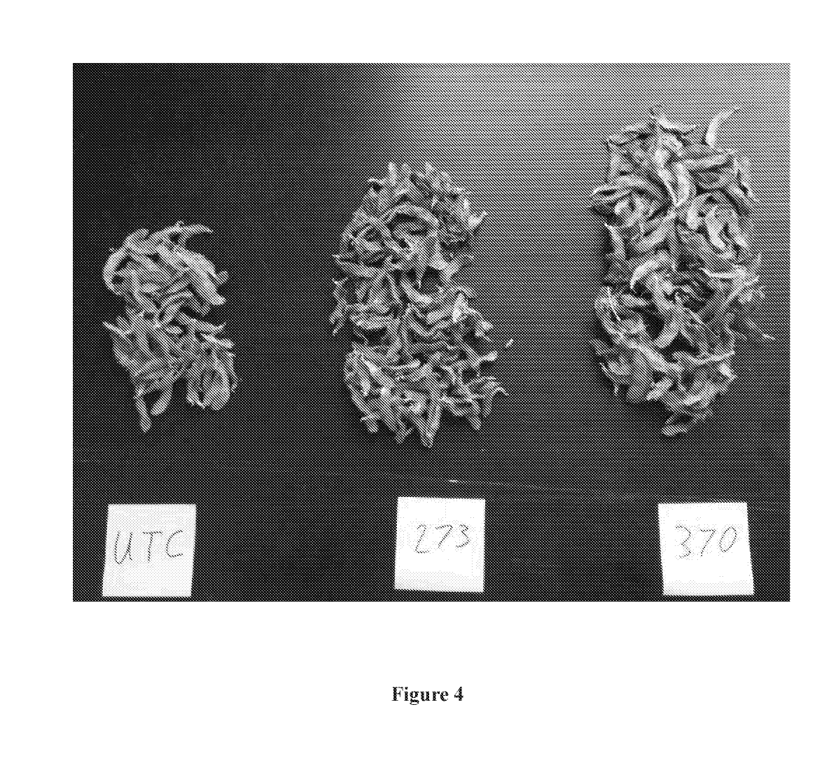

The data are shown in Tables 6-8, and in FIG. 4

TABLE 6
Germination at low temperature

| Seed treatment | % Germination |
|---|---|
| Untreated | 81.3 |
| Strain 273 | 79.0 |
| Strain 370 | 95.8 |

TABLE 7
Harvest data for Garden Mix

| | | Number | | | |
|---|---|---|---|---|---|
| | SPAD | of pods | Dry shoot | Dry pod | Total above- |
| Treatment | (mean) | (mean) | weight (g) | weight (g) | ground mass (g) |
| Untreated | 33.11 | 44.75 | 28.77 | 7.13 | 35.90 |
| Strain 273 | 38.07 | 54.73 | 28.46 | 8.43 | 36.88 |
| Strain 370 | 40.95 | 56.81 | 28.96 | 10.04 | 39.00 |

TABLE 8
Harvest data for sphagnum peat

| | | Number | | | |
|---|---|---|---|---|---|
| | SPAD | of pods | Dry shoot | Dry pod | Total above- |
| Treatment | (mean) | (mean) | weight (g) | weight (g) | ground mass (g) |
| Untreated | 19.98 | 36.87 | 37.87 | 4.82 | 42.69 |
| Strain 273 | 33.19 | 84.94 | 38.98 | 12.65 | 51.62 |
| Strain 370 | 42.44 | 93.86 | 40.96 | 16.90 | 57.86 |

FIG. 4 shows a picture of pods from two random samples of untreated seeds (UTC), strain 273-treated seeds (273) and strain 370-treated seeds, grown in sphagnum peat.

These results indicate (Table 6) that strain 370 had a higher germination rate than both untreated control seeds and seeds treated with strain 273. Strain 370-treated seeds produced plants that contained higher relative amounts of chlorophyll in their leaves than control strains (as determined using a SPAD-502 meter; Tables 7 and 8). In addition strain 370-treated seeds produced plants that had a higher number of pods than both the untreated control seeds and strain 273-treated seeds, both when grown in Garden Mix (Table 7) and in sphagnum peat (Table 8, FIG. 4). The dry pod weight for strain 370-treated seeds was higher than for both untreated control seeds and strain 273-treated seeds grown in sphagnum peat (Table 8). In the Garden Mix, dry pod weight was statistically higher than untreated control seeds (Table 7).

These data indicated that strain 370 provides a benefit to plants in cold weather germination and also indicates that strain 370 is a robust strain that aids in higher soybean yield over the positive control strain 273.

### Example 5. Tolerance of Strain 370 to Various Chemical Compositions

To examine the compatibility of strain 370 with certain chemical compositions commonly used to treat plants, particularly molybdenum, soybean seeds were treated with Apron MAXX® RTA®+Moly from Syngenta (1.02% Mefenoxam, 0.68% Fludioxonil, 4.67% molybdenum). One-hundred grams of soybean seeds were coated with 300 μl of strain 273 or strain 370, with 350 μl of Apron MAXX® RTA®+Moly or, for controls, 350 μl of phosphate buffer. Therefore, the final concentration of molybdenum in seeds coated with a bacterial strain plus Apron MAXX® RTA®+Moly was about 2.5% (260 mM). After coating, the seeds were dried in sealed plastic bags for 4 hours. Triplicate samples of 5 seeds per sample were taken at 4 hours and at 24 hours, placed in 5 ml phosphate buffer and allowed to imbibe for 2 hours. Microbe viability was determined by serial dilutions of the phosphate buffer, plating onto YEMA plates, incubating the plates at 30° C. for 6-7 days, and counting visible colonies. The data are shown in Table 9.

TABLE 9
Viability after coating with Apron MAXX ® RTA ® + Moly

| Treatment | 4 hrs | 24 hrs |
|---|---|---|
| Strain 273 | 4.5 × 10⁵ (1.000) | 2.3 × 10⁵ (0.511) |
| Strain 273 + Apron Maxx ® | 4.3 × 10³ (0.010) | 1.7 × 10³ (0.004) |
| Strain 370 | 1.2 × 10⁶ (1.000) | 1.0 × 10⁶ (0.833) |
| Strain 370 + Apron Maxx ® | 1.4 × 10⁵ (0.117) | 1.2 × 10⁵ (0.100) |

The data indicate that strain 273 had about a 100-fold drop (2 logs) in viability at 4 hours when Apron MAXX® RTA®+Moly was used in the seed coating. Strain 370 exhibited about a 10-fold drop (1 log) at 4 hours with Apron MAXX® RTA®+Moly. At 24 hours, strain 273 had about a 500-fold drop (2.5 logs) in viability when Apron MAXX® RTA®+Moly was used in the seed coating. Strain 370 exhibited about a 10-fold loss (1 log) in presence of Apron MAXX® RTA®+Moly. The data indicate that strain 370 was more tolerant to Apron MAXX® RTA®+Moly than was strain 273.

In a similar study, tolerance of Bradyrhizobium strains to CruiserMaxx™ from Syngenta was studied. The active ingredients in CruiserMaxx™ are thiamethoxam (22.61%), mefenoxam (1.70%), and fludioxonil (1.12%).

Since it was not possible to filter-sterilize CruiserMaxx™, YEM agar plates were prepared that contained 100 μg polymixin B per ml to prevent possible contamination by Bacillus. To 100 ml of YEM agar, was added one of 10 μl, 100 μl, 1 ml or 5 ml of CruiserMaxx™. Control plates contained no CruiserMaxx™. Bradyrhizobium japonicum strains 273, 370, USDA 110 and 21196 were streaked on the plates. The data showed that, at 5 ml of added CruiserMaxx™, the 370 strain had the highest level of tolerance to CruiserMaxx™.

### Example 6. Tolerance of Strain 370 to Glyphosate

To test tolerance to glyphosate, the ability of the 273 and 370 strains to grow on agar plates containing glyphosate was examined. YEM plates containing 1 and 2 mM glyphosate PESTANAL® (C₃H₈NO₅P; SIGMA-ALDRICH) were prepared. Control plates contained no glyphosate. All plates also contained 100 μg polymixin B/ml to prevent contamination. This concentration of polymixin B does not affect growth of the tested Bradyrhizobium strains. The pH of all plates was 6.8.

Strains 273 and 370 were streaked onto the plates, inverted and incubated at 30° C. Plates were observed for growth 7 days later. No growth is indicated as (−). Growth is indicated as (+, ++ or +++), depending on extent of growth. The data are shown in Table 10.

TABLE 10
Tolerance to glyphosate

| Strain | No glyphosate | 1.0 mM glyphosate | 2.0 mM glyphosate |
|---|---|---|---|
| 273 | +++ | +++ | ++ |
| 370 | +++ | +++ | +++ |

The data show that the 370 strain is more tolerant to glyphosate than is the control 273 strain.

### Example 7. Growth Tolerance to High Temperature

To determine whether strain 370 had differences in ability to grow at increased temperatures as compared to the 273, USDA 110, and 21196 strains, growth curves were generated at 30° C. and at 38° C. Cells were grown in AG medium (0.236 g/l Na₂HPO₄.7H₂O, 0.25 g/l Na₂SO₄, 0.32 gl NH₄Cl, 0.18 g/l MgSO₄.7H₂O, 0.0067 g/l FeCl₃.6H₂O, 0.013 g/l CaCl₂.2H₂O, 1.3 g/l HEPES, 1.1 g/l MES, 1 g/l yeast extract, 1 g/l arabinose, 1 g/l gluconic acid σ lactone, pH 6.8). Starter cultures of each strain were grown in tubes containing 5 ml of AG medium at 30° C. until they reached an OD₆₀₀ of 0.6-0.7. These cultures were used to inoculate 250 ml cultures to a starting OD₆₀₀ of 0.01. Three replicates of each strain were grown at both 30° C. and 38° C. with shaking at 200 rpm. Growth was quantified by measurement of OD₆₀₀.

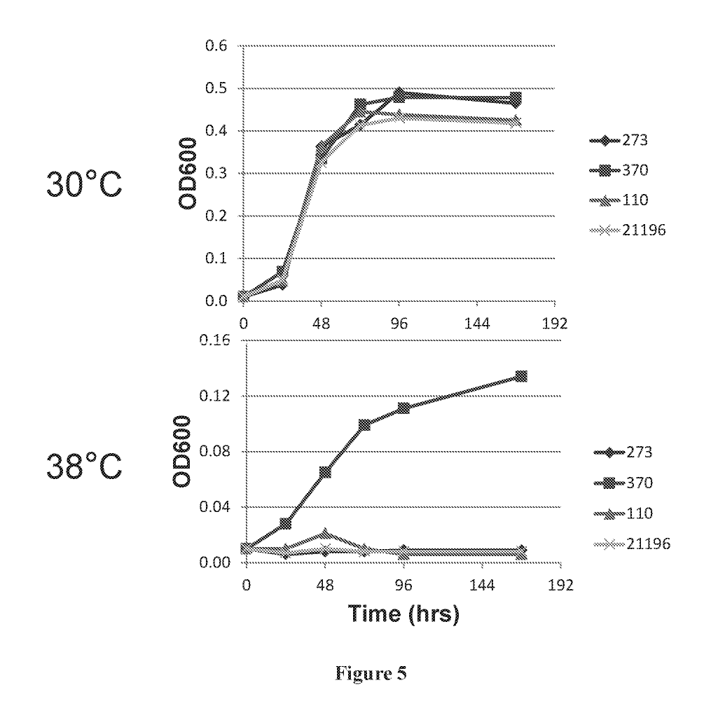

The data, shown in FIG. 5, indicated that the 273, USDA 110, 21196 and 370 strains have a similar growth profile at 30° C. with strain 370 reaching the highest OD₆₀₀ in stationary phase. At 38° C., however, the 370 strain was able to divide, whereas the 273, USDA 110 and 21196 strains were not.

While example compositions, methods, and so on have been illustrated by description, and while the descriptions are in considerable detail, it is not the intention of the applicants to restrict or in any way limit the scope of the application. It is, of course, not possible to describe every conceivable combination of components or methodologies for purposes of describing the compositions, methods, and so on described herein. Additional advantages and modifications will readily appear to those skilled in the art. Therefore, the invention is not limited to the specific details and illustrative examples shown and described. Thus, this application is intended to embrace alterations, modifications, and variations that fall within the scope of the application. Furthermore, the preceding description is not meant to limit the scope of the invention.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

### Deposit of Biological Material

At least the following biological material has been deposited under the terms of the Budapest Treaty with the Agricultural Research Service Patent Culture Collection (NRRL), Northern Regional Research Center, 1815 N. University Street, Peoria, Ill., 61604, USA, and identified as follows: Bradyrhizobium japonicum strain 370 (NRRL B-50728), deposited on Mar. 9, 2012.

### INCORPORATION BY REFERENCE

The content of U.S. Pat. No. 8,999,698 (Ser. No. 13/436,268), filed on Mar. 30, 2012, and issued on Apr. 7, 2015, is herein incorporated by reference in its entirety.

1. A method, comprising:
supplying to a plant, a Bradyrhizobium bacterium that is tolerant or partially tolerant to multiple environmental conditions adverse for the bacterium.

2. The method of claim 1, where the Bradyrhizobium bacterium is Bradyrhizobium japonicum.

3. The method of claim 1, where the Bradyrhizobium bacterium is Bradyrhizobium japonicum strain 370.

4. The method of claim 1, where the environmental conditions adverse for the bacterium include conditions or states that are not optimal for one or more of bacterium viability, bacterium growth or division, and ability of the bacterium to function.

5. The method of claim 1, where the multiple adverse environmental conditions include at least two of: coating the bacterium onto a seed, exposure of the bacterium to low temperature, exposure of the bacterium to molybdenum, exposure of the bacterium to glyphosate, and exposure of the bacterium to high temperature.

6. The method of claim 5, where tolerant or partially tolerant to coating the bacterium onto a seed includes less than 90.0% loss of viability of the bacterium after 3 days on the seed, when the bacterium is coated onto seeds in YEM media and the seeds are stored at about 21-23° C.

7. The method of claim 5, where tolerant or partially tolerant to exposure of the bacterium to low temperature includes a low temperature of less than about 60° F. (16° C.).

8. The method of claim 5, where tolerant or partially tolerant to exposure of the bacterium to molybdenum includes a molybdenum concentration of at least 260 mM.

9. The method of claim 5, where tolerant or partially tolerant to exposure of the bacterium to glyphosate includes a glyphosate concentration of about 2 mM or greater.

10. The method of claim 5, where tolerant or partially tolerant to exposure of the bacterium to high temperature includes ability of the bacterium to divide at about 100° F. (38° C.) in culture.

11. The method of claim 1, where tolerant or partially tolerant means that the bacterium retains or partially retains one or more of viability, ability to grow or divide, ability to function, and ability to facilitate plant growth, when exposed to the multiple environmental conditions adverse for bacteria.

12. The method of claim 1, where the bacterium that is tolerant or partially tolerant is better able to tolerate the multiple environmental conditions adverse for bacteria than are one or more of Bradyrhizobium japonicum strains 273, 273-17, 518 (NRRL B-50729), 727 (NRRL B-50730), and 790.

13. The method of claim 1, where supplying to a plant includes applying the bacterium to one or both of a seed and a furrow in which a seed or a seedling is planted.

14. The method of claim 1, where the plant includes leguminous plants.

15. The method of claim 14, where the leguminous plants include soybean.

16. The method of claim 1, including growing the plant.

17. The method of claim 16, where growing the plant includes growing the plant under at least one environmental condition adverse for the plant.

18. The method of claim 17, where the environmental condition adverse for the plant includes at least one of a high temperature, a low temperature, presence of molybdenum, and presence of glyphosate.

19. The method of claim 18, where the environmental condition adverse for the plant includes a low temperature, the low temperature being a temperature, at or below which, seeds of the plant germinate slower or at a lower rate as compared to an optimum temperature for seed germination.

20. The method of claim 1, where the bacterium supplied to the plant also includes one or both of a Penicillium fungus and an LCO.
